(19) United States
(12) Patent Application Publication
(10) Pub. No.: US 2006/0221222 A1
(43) Pub. Date: Oct. 5, 2006

(54) Reproducing apparatus and display controlling method

(75) Inventor: Tsutomu Hirasawa, Saitama (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/346,431

(22) Filed: Feb. 3, 2006

(30) Foreign Application Priority Data
Feb. 24, 2005 (JP) P2005-049097

(51) Int. Cl. H04N 5/76; H04N 5/222

(52) U.S. Cl. 348/333.01; 348/231.2

(57) ABSTRACT

Disclosed herein is a reproducing apparatus for reproducing picture data from a recording medium, the apparatus including: a reading device reading picture data from the recording medium on which the picture data is recorded; and a controlling device controlling a predetermined sequence display mode and a random sequence display mode in which the picture data is read by the reading device from the recording medium for display, the predetermined sequence display mode being a mode in which a plurality of items of the picture data are output for display in a predetermined sequence, the random sequence display mode being a mode in which the plurality of items of the picture data are output for display in a random sequence, the controlling device further switching the picture data for consecutive display in a first display style when the predetermined sequence display mode is in effect and in a second display style when the random sequence display mode is in effect, the second display style being different from the first display style in terms of picture data switchover on a display screen.

### CROSS REFERENCES TO RELATED APPLICATIONS

The present invention contains subject matter related to Japanese Patent Application JP 2005-049097 filed with the Japanese Patent Office on Feb. 24, 2005, the entire contents of which being incorporated herein by reference.

### BACKGROUND OF THE INVENTION

The present invention relates to a reproducing apparatus and a display controlling method for use therewith.

There exist diverse apparatuses capable of reproducing and displaying picture data recorded on recording media. For example, widely popularized digital still cameras use the solid-state image pickup device such as a CCD sensor or a CMOS sensor to pick up picture signals of objects and record what is acquired as picture data to recording media. The recording media to which to record the pickup data (i.e., still picture data) include a memory card containing a flash memory, an optical disc, a magneto-optical disc, and a hard disc (magnetic disc). In the case of DCF-compliant digital cameras that are prevalent today, the pickup data is classified by a FAT system into folders before being recorded. In response to a user's operations, the pickup data thus recorded can be displayed on a display unit.

Various kinds of disc media have been developed, including CD (Compact Disc), MD (Mini Disc), DVD (Digital Versatile Disc), and Blu-Ray Disc for use with diverse data recording and reproducing systems that handle audio data, video data, and computer-use data. With these disc media getting larger in capacity, more and more electronic devices have been developed with hybrid functions taking advantage of the large-volume media. For example, miniature portable audio reproducing apparatus that use disc media have been introduced. In recent years, some portable audio players incorporate a picture display function and/or a digital camera function. These apparatuses have their display unit retrieve and display picture data from their recording media on which not only the picture data but also music content data are stored.

### SUMMARY OF THE INVENTION

The above apparatuses with their still picture display function are capable of so-called slide show reproduction, a feature that allows a plurality of pictures to be automatically reproduced from the recording medium and switched one by one for consecutive display. With regard to slide show reproduction, two modes are known: one in which pictures are reproduced successively in a predetermined sequence, and another in which the pictures are reproduced randomly. The predetermined sequence typically refers to the order in which picture data was filed successively by file number or recorded chronologically on the recording medium. On digital cameras, picked-up pictures are generally assigned file numbers in the order in which they were taken. For purpose of illustration and simplification, the mode in which to perform slide show reproduction in the predetermined sequence is called normal slide show mode. When recorded pictures are reproduced through random selection and retrieval from the recording medium for consecutive display, the pictures are said to be reproduced in shuffle slide show mode.

Some reproducing apparatuses are switched for operation in normal slide show mode or in shuffle slide show mode. It is desirable for such reproducing apparatuses to let the user recognize intuitively which mode is being selected at the moment.

Furthermore, it will be more fun for users if hybrid feature apparatuses capable of reproducing both audio content data and picture data can perform a slide show while reproducing the audio content. Users will feel enjoying more convenience if they are able to recognize intuitively which of the two audio reproduction modes (one in which content data is reproduced in a predetermined sequence by content number and the other in which the data is reproduced randomly) is currently in effect.

The present invention has been made in view of the above circumstances and provides arrangements such that users can have more fun by recognizing more easily which operation mode is in use while a slide show is in progress with or without ongoing reproduction of audio content data.

In carrying out the present invention and according to one embodiment thereof, there is provided a reproducing apparatus for reproducing picture data from a recording medium, the reproducing apparatus including: a reading device reading picture data from the recording medium on which the picture data is recorded; and a controlling device controlling a predetermined sequence display mode and a random sequence display mode in which the picture data is read by the reading device from the recording medium for display, the predetermined sequence display mode being a mode in which a plurality of items of the picture data are output for display in a predetermined sequence, the random sequence display mode being a mode in which the plurality of items of the picture data are output for display in a random sequence, the controlling device further switching the picture data for consecutive display in a first display style when the predetermined sequence display mode is in effect and in a second display style when the random sequence display mode is in effect, the second display style being different from the first display style in terms of picture data switchover on a display screen.

According to another embodiment of the present invention, there is provided a display controlling method for reproducing picture data from a recording medium, the display controlling method including the steps of: determining whether a predetermined sequence display mode or a random sequence display mode is in effect, the predetermined sequence display mode being a mode in which a plurality of items of the picture data are output for display in a predetermined sequence, the random sequence display mode being a mode in which the plurality of items of the picture data are output for display in a random sequence; if the predetermined sequence display mode is found in effect, then outputting the plurality of items of the picture data for display in the predetermined sequence while switching the picture data for consecutive display on a display window in a first display style; and if the random sequence display mode is found in effect, then outputting the plurality of items of the picture data for display in the random sequence while switching the picture data for consecutive display on the display window in a second display style different from the first display style.

According to a further embodiment of the present invention, there is provided a reproducing apparatus for reproducing audio data and picture data from a recording medium, the reproducing apparatus including: reading means reading the audio data and the picture data from the recording medium; audio reproducing means reproducing the audio data read from the recording medium; picture data reproducing means reproducing the picture data read from the recording medium; inputting means inputting either a predetermined sequence reproduction setting or a random sequence reproduction setting specifying whether the audio data is to be reproduced in a predetermined sequence or in a random sequence by audio reproducing means; picture switchover controlling means controlling switchover from one picture to another derived from the picture data reproduced by picture data reproducing means; and a controlling device allowing the audio data to be reproduced by audio reproducing means in the predetermined sequence if the predetermined sequence reproduction setting is input through inputting means while causing picture switchover controlling means to perform the picture switchover in a predetermined style, controlling means further allowing the audio data to be reproduced in the random sequence if the random sequence reproduction setting is input through inputting means while causing picture switchover controlling means to perform the picture switchover in a random style.

### BRIEF DESCRIPTION OF THE DRAWINGS

FIGS. 1A, 1B, 1C, 1D, 1E and 1F are a front view, a plan view, a left side view, a right side view, a bottom view, and a rear view of a combination audio-camera apparatus practiced as one embodiment of the present invention;

FIGS. 2A and 2B are explanatory views showing how a lens cover of the embodiment is opened and closed;

FIG. 3 is a block diagram of the combination audio-camera apparatus embodying the invention;

FIG. 4 is a block diagram of a camera/LCD block in the embodiment of the present invention;

FIG. 5 is an explanatory view showing how files are managed according to the embodiment;

FIGS. 6A and 6B are explanatory views showing how a thumbnail file is structured according to the embodiment;

FIG. 7 is an explanatory view showing how thumbnail files are recorded under subdirectories organized by the embodiment;

FIG. 8 is an explanatory view showing slide show-related functions implemented by the CPU of the embodiment;

FIG. 9 is a flowchart of steps constituting a slide show process performed by the embodiment;

FIGS. 10A and 10B are flowcharts of steps in which slide shows are controlled in two modes by the embodiment;

FIGS. 11A through 11J are explanatory views showing how displays are performed in normal slide show mode of the embodiment; and

FIGS. 12A through 12J are explanatory views showing how displays are carried out in shuffle slide show mode of the embodiment.

### DESCRIPTION OF THE PREFERRED EMBODIMENTS

What follows are explanations of a reproducing apparatus embodying the present invention and a display controlling method which also embodies the invention and which is used in conjunction with the reproducing apparatus. More particularly, a portable combination audio-camera apparatus offering functions of both an audio player and a camera will be described as the reproducing apparatus, together with the way the apparatus operates to effect displays. The inventive combination audio-camera apparatus reproduces audio data from an optical disc used as a recording medium. The apparatus also records picked-up picture data (pickup data) and thumbnail data derived therefrom to the optical disc. From the optical disc, the apparatus further reproduces and displays picture data recorded through image pickup operations, picture data recorded in association with audio content data, or thumbnail data corresponding to such picture data. The description of how the present invention is typically embodied will be given under the following headings:

[1. External structure of the combination audio-camera apparatus]

[2. Internal structure of the combination audio-camera apparatus]

[3. Organization of file management]

[4. CPU functions related to the slide show operation]

[5. Typical slide show processes]

[6. Effects and variations of the embodiment]

### 1. External Structure of the Combination Audio-Camera Apparatus

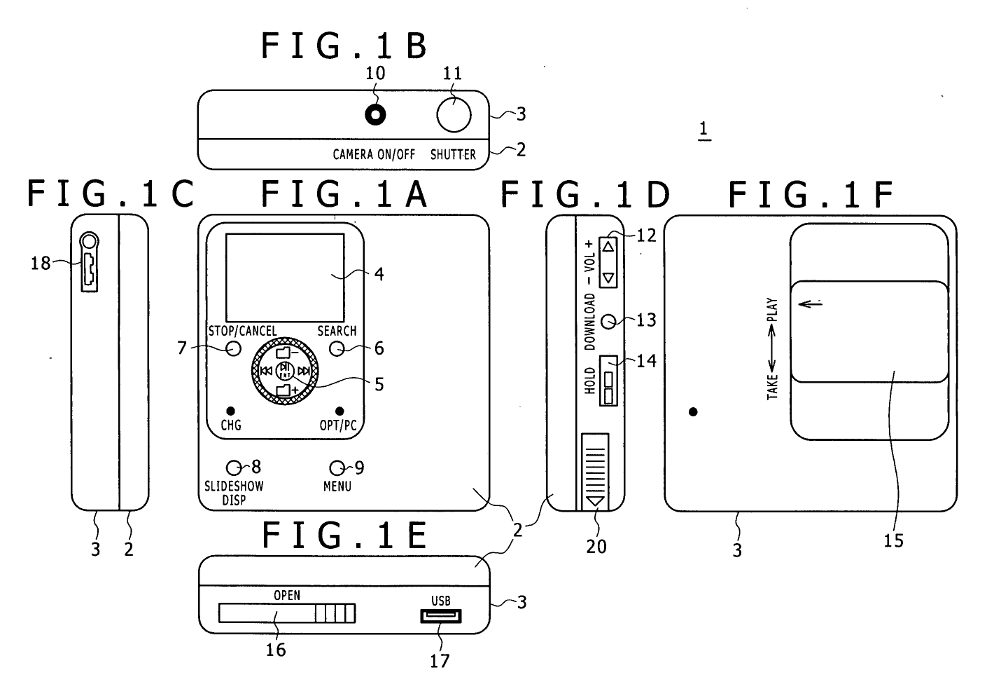

FIGS. 1A, 1B, 1C, 1D, 1E and 1F are a front view, a plan view, a left side view, a right side view, a bottom view, and a rear view of the combination audio-camera apparatus 1 practiced as one embodiment of the present invention. The enclosure of the combination audio-camera apparatus 1 is made up of an upper enclosure 2 and a lower enclosure 3. The upper enclosure 2 is structured to be opened and closed relative to the lower enclosure 3. Although not shown in detail, the upper enclosure 2 is opened by operation of an open/close button 16 appearing in FIG. 1E. Opening the upper enclosure 3 reveals a Mini-Disc (registered trademark) type disc loading mechanism. With a disc loaded and with the upper enclosure 2 closed, the recording or reproduction of information to or from the disc is started inside the enclosure. Loading the disc prompts the combination audio-camera apparatus 1 to start reproducing audio data (pieces of music, etc.) recorded on the disc and thereby function as a portable audio player. Because pickup data can be written and read to and from the disc, the combination audio-camera apparatus also functions as a digital still camera. In the description that follows, the apparatus is said to be in audio mode when functioning as an audio player and in camera mode when operating a s a digital still camera.

As shown in FIG. 1A, the enclosure front is furnished with a display unit 4 such as a liquid crystal display panel. The display unit 4 displays diverse kinds of information: a table of audio data to choose from the optical disc, an operation menu, the track number of a tune being reproduced, time information such as a current playing time and a total playing time, an operation guide, album jacket pictures, and pictures associated with tracks. During audio reproduction, the display unit 4 may display thumbnails as slide show pictures that are switched either in a random sequence in shuffle slide show mode or in a predetermined sequence illustratively by picture data file number in normal slide show mode. With camera mode in effect and with the apparatus in a pickup standby state, the display unit 4 displays a picture of an object currently picked up by the image pickup device (i.e., a moving picture). With the apparatus still in the pickup standby state, the display unit 4 may display a still picture (i.e., photo image) taken by operation of a shutter. When the apparatus is in a photo browse state, the display unit 4 may display reproduced pictures of the photos taken in the past (i.e., pickup data recorded on the optical disc) or their thumbnails. In camera mode, the display unit 4 may also display thumbnails consecutively in shuffle slide show mode or in normal slide show mode.

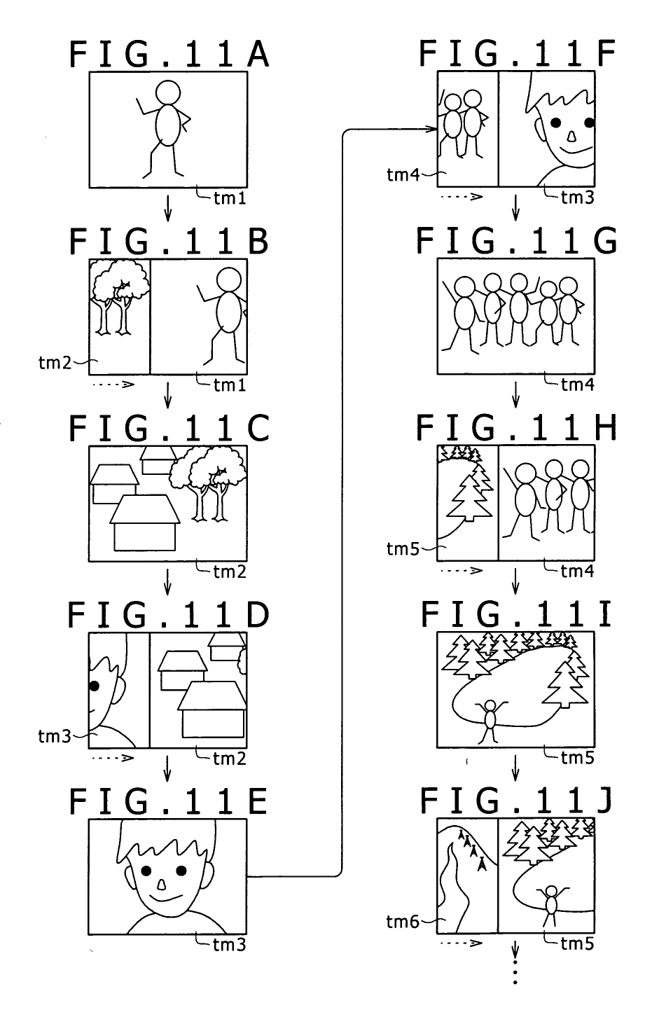

The enclosure has a variety of switches and controls located on it. As shown in FIG. 1A, the enclosure front has a central controller 5, a search key 6, a stop/cancel key 7, a slide show/display key 8, and a menu key 9. As indicated in FIG. 1B, the enclosure top has a camera on/off key 10 and a shutter button 11. The enclosure side, as depicted in FIG. 11D, has a volume key 12, a download key 13, and a hold switch 14.

The central controller 5 is used to perform a majority of operations in audio mode or camera mode. A projection in the middle of the central controller 5 may be pushed down to effect a push operation. The projection may also be tilted up, down, leftward, or rightward to effect up, down, leftward, or rightward operations respectively. The periphery of the central controller 5 constitutes a so-called jog dial that may be rotated clockwise or counterclockwise in a jog operation. In each of different modes, the push, up, down, leftward, rightward, and jog operations are assigned predetermined functions. Illustratively, a user mainly operates the central controller 5 to reproduce, to pause, to stop, to move a cursor in menus and tables on the display, to enter, to change modes, to feed tracks forward/backward, or to fast forward or rewind.

The search key 6 is used to carry out searches. The stop/cancel key 7 is a key for stopping reproduction or for canceling various operations. The slide shown/display key 8 is operated to select illustratively a shuffle slide show or a normal slide shown during audio reproduction or in camera mode, any of various display modes, or any one of content items on the display. The menu key 9 is used to turn on and off an operation menu display on the display unit 4. The camera on/off key 10 is a key for activating and terminating camera mode. The shutter button 11 is used to designate the timing of picture pickup in camera mode. That is, the shutter button 11 is operated to take photo images. The volume key 12 is a key that adjusts sound volume when operated during audio reproduction. The download key 13 is used to trigger a data download when the combination audio-camera apparatus 1 is connected illustratively to a personal computer. The hold switch 14 is a slide switch that may be set to deactivate the other switches and controls (i.e., put them on hold) so as to eliminate inadvertent operations while the apparatus is being carried around by the user.

The enclosure front, as shown in FIG. 1E, has a USB terminal 3 that may connect illustratively to a personal computer through a USB interface. As indicated in FIG. 1C, the enclosure side has a headphones/remote controller terminal 18 to which remote controller-equipped headphones may be connected. The enclosure side, as shown in FIG. 1D, also has a battery box open/close latch 20. Opening the battery box open/close latch 20 makes it possible to load the battery into the enclosure or unload it therefrom.

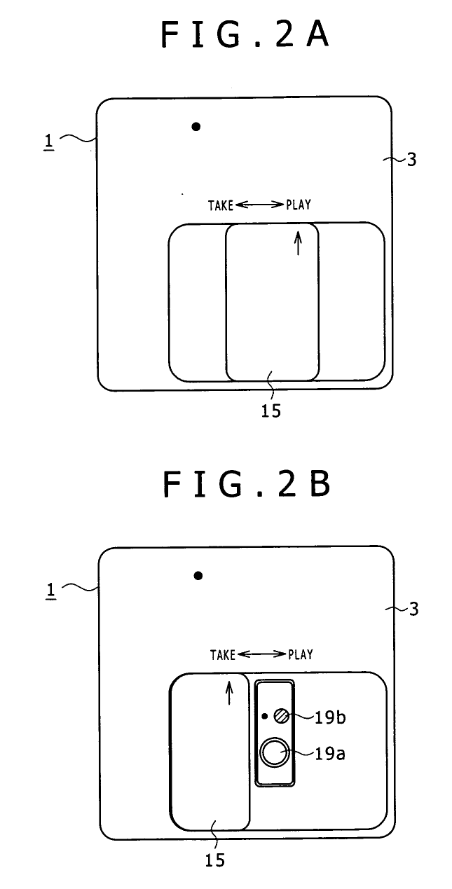

As shown in FIG. 1F, the enclosure rear has a lens cover 15 that slides when manipulated. The lens cover 15 is provided to protect a pickup lens part. FIGS. 2A and 2B illustrate how the lens cover 15 slides open and shut. More specifically, the lens cover 15 slides shut as shown in FIG. 2A and slides open as indicated in FIG. 2B. Opening the lens cover 15 as shown in FIG. 2B reveals a pickup lens 19a and a flash emitting device 19b, which gets the apparatus ready for a camera operation. Closing the lens cover 15 as indicated in FIG. 2A conceals the pickup lens 19a and flash emitting device 19b for lens protection. With this embodiment, the slide operation of the lens cover 15 triggers transition from audio mode to camera mode or vice versa.

### 2. Internal Structure of the Combination Audio-Camera Apparatus

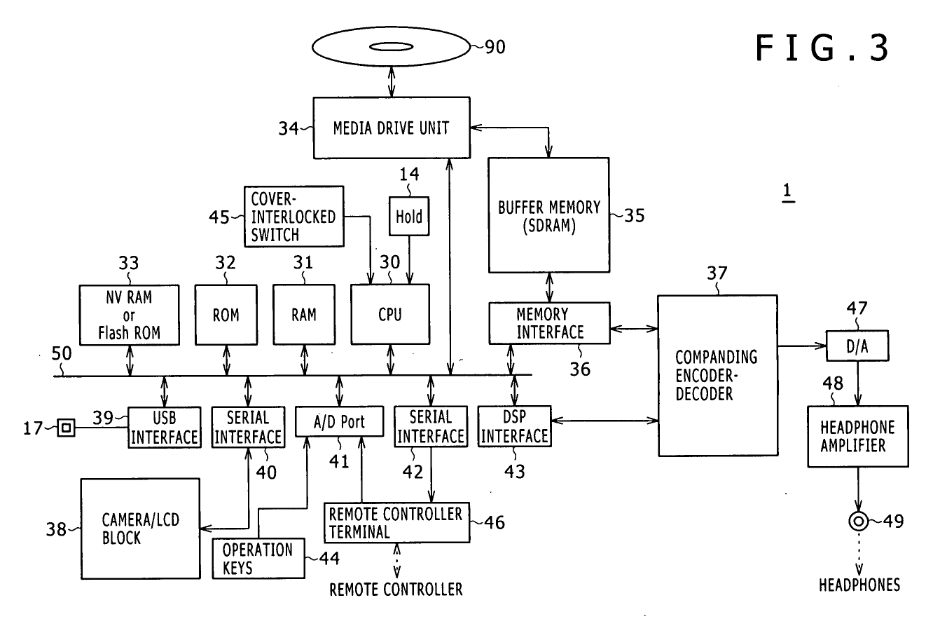

The internal structure of the combination audio-camera apparatus 1 will now be described by referring to FIG. 3. A CPU 30 functions as a controller for the entire apparatus. As such, the CPU 30 controls audio reproduction in audio mode, picture-taking or picture-reproducing operations in camera mode, and display operation on the display unit 4; detection of user-initiated operations, transition between operation modes, and communications with an external apparatus. Over a bus 50, the CPU 30 exchanges data and control information with relevant components of the apparatus. A RAM 31 is used by the CPU 30 as a work area for computations or for storage of information during operation. A ROM 32 is used to retain the programs to be executed by the CPU 30 as well as coefficients and other data used by the latter during processing. A nonvolatile memory 33 (e.g., NV-RAM or a flash ROM) is used to accommodate coefficients, settings, resume points (i.e., addresses from which to resume operation), and other information to be retained while power is being removed.

A media drive unit 34 performs write and read operations to and from a disc 90 such as a Mini-Disc type optical disc (or a magneto-optical disc) under control of the CPU 30. These operations are carried out by the unit 34 composed of an encoder for encoding data in a format ready for recording to the disc 90, a decoder for decoding data reproduced from the disc 90, a read-write head, a servo mechanism, and a spindle motor mechanism. A buffer memory 35 is formed illustratively by an SD-RAM. The buffer memory 35 buffers data being transferred to the media drive unit 34 for recording to the disc 90, or data being read by the media drive unit 34 from the disc 90. During audio reproduction, the buffer memory 35 buffers audio data being read from the disc 90. When the disc 90 is loaded, management information recorded on the disc, i.e., physical information, area information, and recorded data file information necessary for writing and reading data to and from the disc 90, are read by the media drive unit 34 (in what is known as a system read operation) under control of the CPU 30. These items of management information are written to a suitable area of the buffer memory 35 in a manner conducive to being referenced by the CPU 30. Alternatively, the CPU 30 may transfer the management information from the buffer memory 35 into the RAM 31 for reference purposes. With this embodiment, as will be discussed later in connection with slide show operations, thumbnail files containing the thumbnail data to be displayed are read from the disc 90 and written to an appropriate area of the buffer memory 35. A memory interface 36 controls the transfer of data to the buffer memory 35 and manages write/read addresses within the buffer memory 35.

A companding encoder-decoder 37 compression-encodes and expansion-decodes audio data illustratively in keeping with the ATRAC standard. Audio data is decoded by the companding encoder-decoder 37 illustratively into linear PCM data which in turn is converted to an analog audio signal by a D/A converter 47. After the conversion, the analog audio signal is supplied to a headphone amplifier 48. The headphone amplifier 48 amplifies and adjusts the supplied signal in impedance before forwarding the signal to a headphone terminal 49. The headphone terminal 49 is an exposed headphone terminal portion of the headphones/remote controller terminal 18. Through the headphone terminal 49, reproduced sounds are output to plugged-in remote controller-equipped headphones.

Although not shown, if an input section having a line input block, a microphone input block and a digital audio input block is provided to admit an analog audio signal or digital audio data, the input audio signal is fed illustratively to the companding encoder-decoder 37 in digital audio data form for compression encoding. The compression-encoded data is transferred via the buffer memory 35 to the media drive unit 34 for recording to the disc 90. This is how an audio recording function is implemented by the embodiment. When the apparatus is connected illustratively to a personal computer to have audio data downloaded, the downloaded data may be compression-encoded by the companding encoder-decoder 37.

A USB interface 39 permits data transfers between the apparatus and a personal computer or like equipment connected through the USB terminal 17. A serial interface 40 provides data input and output between the apparatus and a camera/LCD block 38, to be described later. An A/D port 41 detects various user-initiated operations, converts what is detected to digital values and supplies the values as operation information to the CPU 30. Operation keys 44 include the above-described central controller 5, search key 6, stop/cancel key 7, slide show/display key 8, menu key 9, camera on/off key 10, shutter button 11, volume key 12, and download key 13. The A/D port 41 supplies the CPU 30 with numerical operation information representing the operations performed on these switches and controls. A remote controller terminal 46 is part of the headphones/remote controller terminal 18 shown in FIG. 1C, the terminal 46 being connected with a remote controller attached to the plugged-in headphones. The information representing the operations performed on the remote controller is detected by the A/D port 41 and transmitted numerically to the CPU 30. A serial interface 42 receives the display data designated by the CPU 30 and forwards the data to the remote controller through the remote controller terminal 46. The remote controller attached to the headphones has a display unit that gives indications based on display control information supplied from the CPU 30 through the serial interface 42.

A DSP interface 43 permits the transfer of data and control information between the components such as the CPU 30 and USB interface 39 attached to a bus 50 on the one hand, and the companding encoder-decoder 37 on the other hand. An operation on the hold key 14 is detected by the CPU 30. If the hold key 14 is found operated to deactivate the other keys, the CPU 30 considers invalid any operation information coming from the operation keys 44 through the A/D port 41.

A cover-interlocked switch 45 is turned on and off in interlocked relation to the opening and closing of the lens cover 15. That is, the switch 45 functions as a detector detecting the open/close state of the lens cover 15. By checking to see if the cover-interlocked switch 45 is on or off, the CPU 30 can verify whether the lens cover 15 is opened or closed.

The camera/LCD block 38 is made up of an image pickup processing section and a display processing section that has the display unit 4. The image pickup processing section includes: the above-mentioned solid-state image pickup device such as a CCD sensor or a CMOS sensor for picking up light of an object, the light being incident from the pickup lens block 19; a pickup signal transfer circuit that acquires pixel signals transferred from the solid-state image pickup device for gain control and A/D conversion; a digital processing section that performs white-balance calibration and Y/C processing on the pickup picture data acquired by the pickup signal transfer circuit; and an encoding section that provides compression and formatting of the pickup picture data. The display processing section includes: a display picture processing device that creates pictures, text and characters to be displayed on the LCD serving as the display unit 4; and a display drive circuit that drives the LCD based on the pictures to be displayed.

In audio mode, the above-described combination audio-camera apparatus reproduces audio data from the disc 90. When the user performs a reproduction operation by manipulating the operation keys 44 or the remote controller, the CPU 30 causes the media drive unit 34 to reproduce audio files (i.e., audio tracks) from the disc 90. The audio data reproduced by the media drive unit 34 is accumulated in the buffer memory 35 before being read successively and transferred to the companding encoder-decoder 37 for decoding by the latter. The decoded data is converted to an analog audio signal by the D/A converter 47. After the conversion, the analog audio signal is processed by the headphone amplifier 48 and output audibly from the plugged-in headphones. While audio mode is being in effect, the display unit 4 and display processing section in the camera/LCD block 38 carry out display-related operations under control of the CPU 30, showing a play menu (e.g., a table of tune names), the name of the currently reproduced tune, the name of the artist associated with the ongoing reproduction, time information, jacket pictures, and slide show pictures.

With the apparatus in camera mode and with the pickup standby state in effect, the CPU 30 causes the camera/LCD block 38 to pick up a picture of an object, process picture signals, and display the picture of the object currently picked up (i.e., a moving picture) on the display unit 4. If the user operates the shutter button 11 in that state, the CPU 30 causes the object picture in effect at that point to be recorded in the form of pickup data (i.e., a still picture). In other words, one-frame picture data in effect upon shutter operation is supplied as recording data to the media drive unit 34 via the buffer memory 35. In turn, the media drive unit 34 records the pickup data as one photo image file to the disc 90. With camera mode still in effect and with the apparatus in the photo browse state, the CPU 30 causes the media drive unit 34 to read photo image file data from the disc 90. The picture data thus retrieved is transferred through the buffer memory 35 to the camera/LCD block 38 and displayed on the display unit 4. The photo image data may be displayed on the display unit 4 in one of two ways: either the data is displayed one picture at a time, or the data is displayed simultaneously as a large number of thumbnails on a single screen. The CPU 30 effects switchover between single-picture display and multiple-thumbnail display in response to the user's operation. It is also possible for the CPU 30 to carry out slide show displays in camera mode.

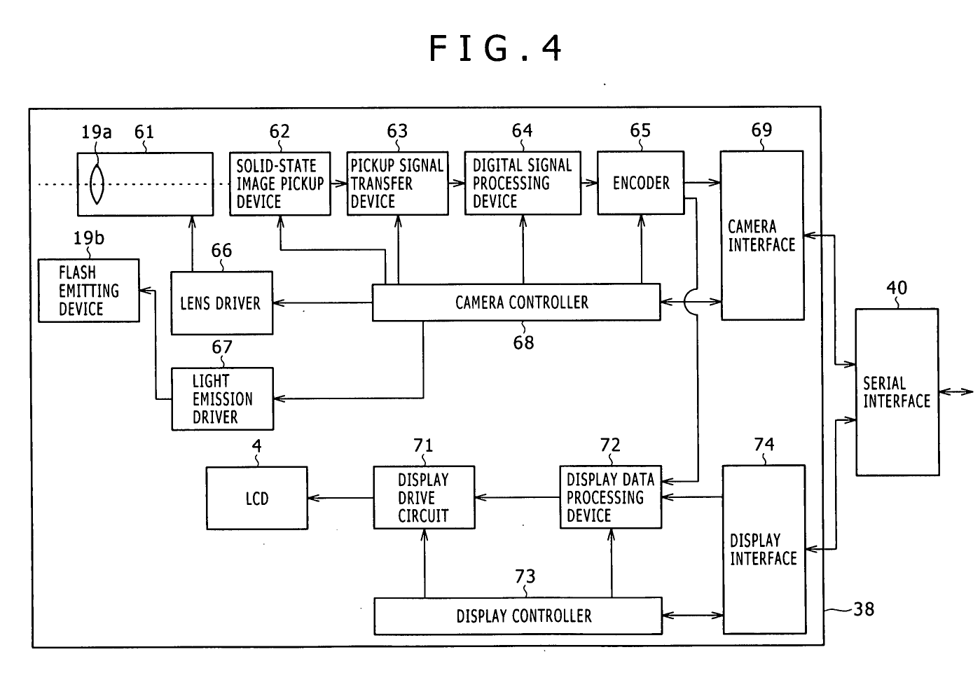

FIG. 4 shows a typical structure of the camera/LCD block 38. As described above, the camera/LCD block 38 includes the image pickup processing section and display processing section. The image pickup processing section has a lens portion 61 including the above-mentioned pickup lens 19a, a solid-state image pickup device 62 acting as an image sensor, a pickup signal transfer device 63, a digital signal processing device 64, an encoder 65, a lens driver 66, a light emission driver 67, a flash emitting device 19b, a camera controller 68, and a camera interface 69.

The lens portion 61 constitutes a lens optics including the pickup lens 19a, a focus lens and a zoom lens. Picked-up light from an object is allowed to enter the solid-state image pickup device 62 that is typically formed by a CCD sensor array or a CMOS sensor array. The pickup signal transfer device 63 obtains signals transferred from the image sensing elements in the solid-state image pickup device 62, samples the acquired signals, controls the sampled signals in gain, and subjects the signals to A/D conversion so as to generate digital picture data. After the conversion, the digital picture data is transferred to the digital signal processing device 64. The digital signal processing device 64 performs white-balance calibration and Y/C processing on the pickup picture data coming from the pickup signal transfer device 63. The encoder 65 carries out compression and formatting on the pickup picture data processed by the digital signal processing device 64, thereby generating illustratively JPEG (Joint Photographic Experts Group) still picture pickup data. The camera interface 69 permits the output and transfer of the pickup picture data through the serial interface 40 as well as the input of control signals from the CPU 30. The lens driver 66 drives the focus lens and zoom lens in the lens portion 61. The light emission driver 67 drives the flash emitting device 19b to emit flash light. The camera controller 68 controls the image pickup processing section in operation under instructions from the CPU 30.

The display processing section in the camera/LCD block 38 has the above-mentioned display unit 4 (LCD), a display drive circuit 71, a display data processing device 72, a display controller 73, and a display interface 74. The display interface 74 permits the input of display data through the serial interface 40 as well as the input of control signals from the CPU 30. The display data processing device 72 stores the display data coming from the display interface 74 or from the above-described image pickup processing section. Furthermore, the display data processing device 72 performs decoding and RGB processes necessary for display output. The display drive circuit 71 admits the display data that was stored in the display data processing device 72 and processed into R, G and B signals. Based on the display data thus admitted, the display drive circuit 71 drives the LCD 4 to effect relevant displays. The display controller 73 controls the display processing section in operation.

In the camera/LCD block 38, the camera controller 68 and display controller 73 cause necessary operations to be carried out by providing control as follows: if the CPU 30 specifies that camera mode is to be in effect, the camera controller 68 causes the pickup signal transfer device 63, digital signal processing device 64, and encoder 65 to pick up a picture of an object and process the picture signal. In this case, until the user operates the shutter button 11, the camera controller 68 transfers the picture (i.e., moving picture) from the encoder 65 to the display data processing device 72 and causes the display drive circuit 71 to display the picture on the LCD 4. This operation is intended to let the user verify what is being imaged. When the shutter button 11 is operated by the user, the CPU 30 causes the picture of the object (i.e., still picture) in effect at that point to be recorded as pickup data. Here, the camera controller 68 causes the one-frame picture data in effect upon shutter operation to be output through the camera interface 69 and serial interface 40. Under control of the CPU 30, the pickup data is supplied as recording data to the media drive unit 34 via the buffer memory 35 so that the data may be recorded to the disc 90 by the drive unit 34. The pickup data is also supplied to the display data processing device 72 and arranged to appear on the LCD 4 by the display drive circuit 71. The user is then able to verify the picture taken.

The camera controller 68 causes the lens driver 66 to perform auto focus and zoom operations automatically or as instructed by the CPU 30 responding to the user's manipulations. In driving the lenses, the camera controller 68 executes switchover between close-up mode and normal mode under instructions from the CPU 30. The camera controller 68 also controls exposure by causing the solid-state image pickup device 62 to adjust charging time and the digital signal processing device 64 to process signals, and sets the picture size for pickup data by suitably controlling the digital signal processing device 64 and encoder 65. Furthermore, the camera controller 68 causes the light emission driver 67 to emit flash light the moment the shutter is operated. Whether or not to emit flash light is designated by the CPU 30 as a setting of flash mode.

In camera mode, the display controller 73 controls the display data processing device 72 and display drive circuit 71 so as to display moving or still pictures supplied from the image pickup processing section as described above. Under instructions from the CPU 30, the display controller 73 further permits the display of picture data transferred from the buffer memory 35 through the serial interface 40 as well as the display of operation menu images, icons, and table images fed from the CPU 30.

### 3. Organization of File Management

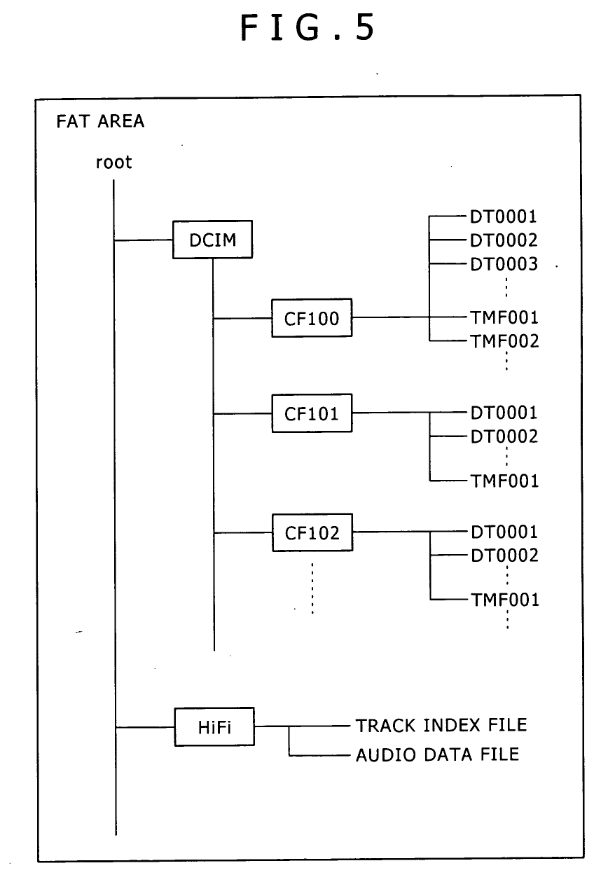

What follows is a description of how picture data (i.e., pickup data) and audio data are organized when they are managed for recording onto the disc 90. The data to be recorded to the disc 90 is managed illustratively under the so-called FAT (file allocation table) file system. As shown in FIG. 5, a DCIM directory and a HiFi directory are located on the root of the FAT file system.

Still pictures (e.g., pickup data) handled by digital camera systems are generally managed in accordance with the camera file system standard (known as the Design rule for Camera File system; DCF standard) of JEIDA (Japan Electronic Industry Development Association). The DCF standard stipulates that the DCIM directory be located on the root. Up to 999 subdirectories CF100, CF101, CF102, etc., may be placed under the DCIM directory. It is stipulated that each subdirectory CFxxx may accommodate picture data constituting up to 9,999 pictures. Any number of pictures smaller than 9,999 may be designed as the maximum picture count. In FIG. 5, characters DT0001, DT0002, etc., denote picture data files subsumed under a subdirectory CFxxx. Each picture data file DT0001, etc., includes header information and thumbnail data in addition to the actual picture data. One or a plurality of thumbnail files are created to accommodate the thumbnail data derived from the picture data files. Such thumbnail files are placed under each subdirectory CFxxx. In FIG. 5, files TMF001, TMF002, etc., represent a thumbnail file each. Each thumbnail file is set to accommodate the thumbnail data constituting up to, say, 100 thumbnails. Any number of picture data files (each representing a single still picture) smaller than an established maximum picture count may be subsumed under each subdirectory CFxxx. For example, the user may place the data of a desired number of pictures under the subdirectory CF100, before proceeding to place the new data of pictures under the next subdirectory CF101. Basically, the number of thumbnail files is determined by the number of picture data files under each subdirectory CFxxx. Suppose that one thumbnail file contains the thumbnail data constituting 100 thumbnails. In this case, if the number of picture data files (i.e., of pickup picture data) subsumed under the subdirectory CFxxx is 100 or less, then a single thumbnail file will suffice. If the number of picture data files falls between 401 and 500, five thumbnail files will be created.

Under the HiFi directory on the root of the FAT file system, Mini-Disc system audio data is managed. A track index file and an audio data file are subsumed under the HiFi directory. The audio data file contains tracks representative of actual audio content data and various kinds of fringe information. These items of actual data are managed in accordance with management information held in the track index file. The track index file, of which the management structure will not be discussed in detail, is structured to manage the recording positions, part structure, and names of the audio tracks as well as the fringe information. The numerous tracks accommodating the audio data are categorized into one or a plurality of groups for management purposes. Illustratively, the tracks are grouped by album, by artist, or by the user's setting. The fringe information includes picture data such as album jacket images. Where audio data is downloaded, picture data may also be downloaded and recorded as fringe information into the audio data file. Thumbnail data may be derived from the picture data acquired as part of the fringe information and managed under the HiFi directory.

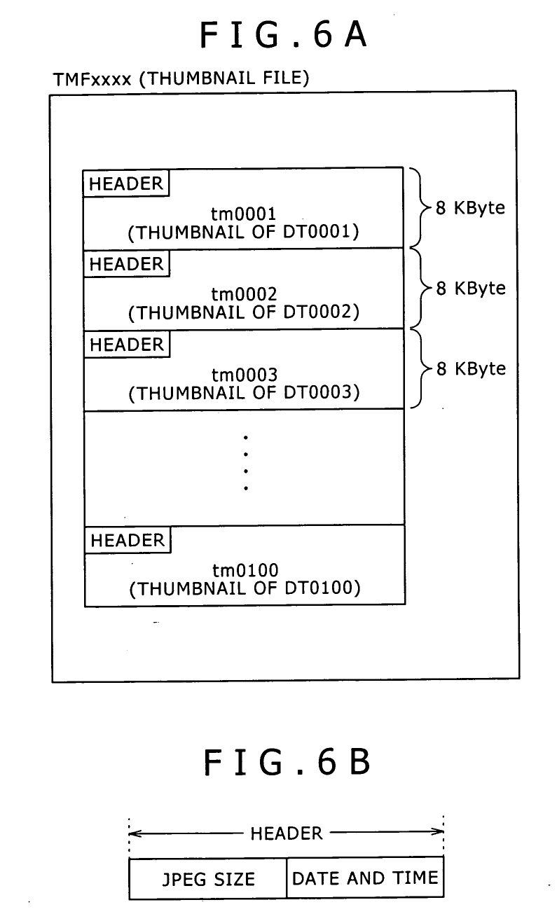

FIGS. 6A and 6B show how a thumbnail file TMFxxxx□ is structured under a subdirectory CFxxx which in turn comes under the DCIM directory. As indicated in FIG. 6A, the thumbnail file TMFxxxx stores the data representing thumbnails each placed in an 8-kilobyte slot with a header. For example, a data item placed in the slot tm0001 is thumbnail data derived from the picture data file DT0001 under the subdirectory CFxxx, the data being picture data compressed illustratively as per the JPEG standard at a rate greater than that of the picture data file DT0001. The thumbnail data item tm0001 is supplemented with the header. As shown in FIG. 6B, this header retains the header size (JPEG size) of the thumbnail data item tm0001 and information specifying the time and date of recording in a format of the day, time of day down to seconds, and calendar year. In like manner, thumbnail data items tm0002, tm0003, etc., are each stored in an 8-kilobyte slot corresponding to a specific picture data file.

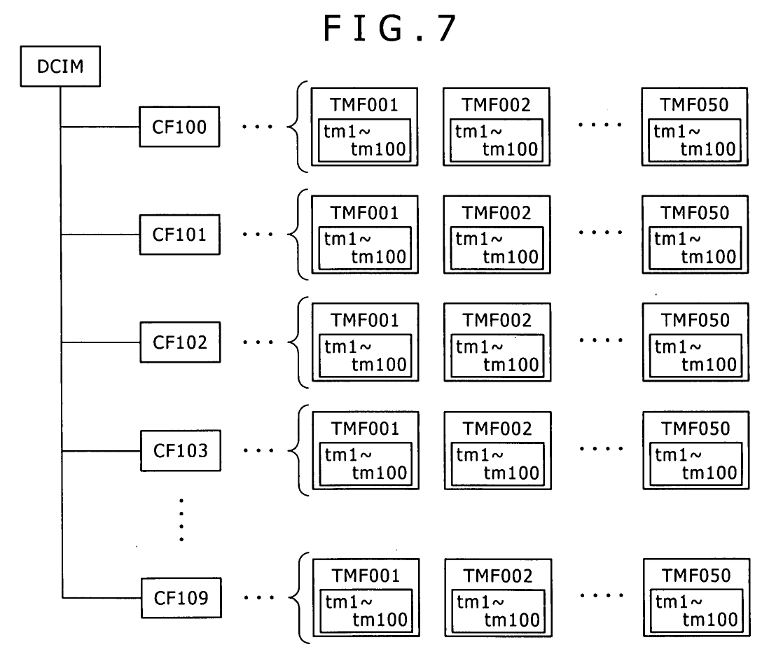

FIG. 7 shows how files are typically recorded under the DCIM directory. In the example of FIG. 7, subdirectories CF100 through CF109 are subsumed under the DCIM directory. Each subdirectory CFxxx accommodates 5,000 picture data files DT, not shown. A total of 50 thumbnail files TMF001 through TMF050 each containing 100 thumbnail data items tm1 through tm100 are thus provided. Obviously, this is only a model example for purpose of illustration. There may be diverse numbers of picture data files DT per subdirectory and/or of thumbnail data items tm per thumbnail file TMF. In some cases, only a few thumbnail data items may be placed in a given thumbnail file TMF.

### 4. CPU Functions Related to the Slide Show Operation

This embodiment of the invention has features allowing the display unit 4 to implement slide shows of picture data. What follows is a description of a typical functional structure of the CPU 30 designed to effect the slide show operation.

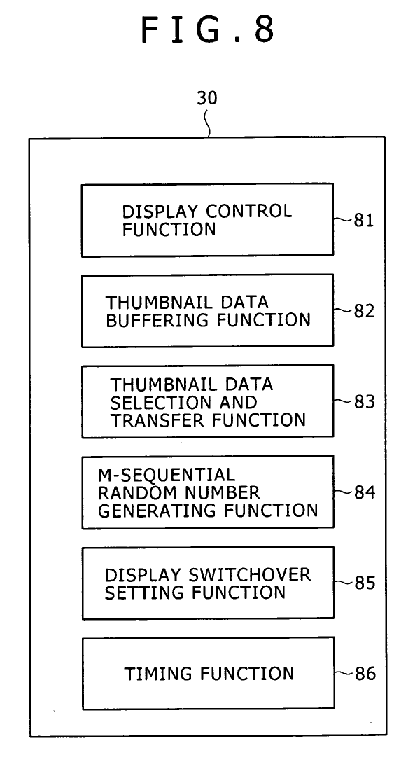

The functional block such as the one shown in FIG. 8 is constituted illustratively by software for execution by the CPU 30 that carries out the slide show. As illustrated in FIG. 8, the structure may include a display control function 81, a thumbnail data buffering function 82, a thumbnail data selection and transfer function 83, an M-sequential random number generating function 84, a display switchover setting function 85, and a timing function 86.

The display control function 81 is a function that controls not only slide shows but also other display operations performed by the display unit 4. More specifically, the display control function 81 instructs the display controller 73 in the camera/LCD block 38 to perform diverse displays. The display control function 81 identifies a user-selected mode for slide show display, i.e., normal slide show mode or shuffle slide show mode, and gives instructions to the other functions with regard to the slide show display mode in effect.

The thumbnail data buffering function 82 controls the reading of thumbnail files TMF from the disc 90 upon execution of slide show display. More specifically, the thumbnail data buffering function 82 controls the media drive unit 34 and memory interface 36 so as to place one or a plurality of thumbnail files TMF necessary for the slide show into the buffer memory 35 in a suitably timed manner. As mentioned above, each thumbnail file TMF contains a plurality of thumbnail data items tm.

The thumbnail data selection and transfer function 83 selects the thumbnail data items used to display the slide show and transfers the selected data items to the camera/LCD block 38. Illustratively, with normal slide show mode in effect, the thumbnail data selection and transfer function 83 instructs the thumbnail data buffering function 83 to buffer the thumbnail files TMF in order of file number. The thumbnail data items tm contained in each buffered thumbnail file TMF are selected therefrom in order of data number and transferred to the camera/LCD block 38. In shuffle slide show mode, the thumbnail data selection and transfer function 83 instructs the thumbnail data buffering function 82 to buffer the thumbnail files TMF randomly. From any one of the buffered thumbnail files TMF, the thumbnail data items tm are selected randomly and transferred to the camera/LCD block 38.

The M-sequential random number generating function 84 generates M-sequential random numbers for random selection. The generated M-sequential random numbers are used by the thumbnail data buffering function 82 to select randomly and buffer the thumbnail files TMF read from the disc 90. Illustratively, there may be two kinds of M-sequential random numbers: those for selecting subdirectories CF, and those for choosing thumbnail files TMF. Furthermore, the M-sequential random number generating function 84 generates M-sequential random numbers for use by the thumbnail data selection and transfer function 83 in selecting randomly the thumbnail data items tm from a buffered thumbnail file TMF and transferring the selected thumbnail data to the camera/LCD block 38. The M sequence is a sequence in which a particular bit pattern (m-sequential pattern) is selected and given an initial value so that every time the sequence is calculated, it yields a different value until the initial value is reached again. More specifically, the degree of a characteristic equation for the M-sequence is determined in consideration of the maximum numbers of subdirectories, thumbnail files TMF, and thumbnail data items tm. A decision based on these numbers makes it possible to prevent the same number from getting generated until a predetermined number of random values have been generated. This arrangement implements shuffle slide show mode in a manner preventing any given thumbnail data item tm from getting selected in duplicate.

The display switchover setting function 85 is used to set and select display switchover operations for switching pictures during a slide show. An example, to be discussed later, of this function involves having the display scrolled as the display switchover operation of the slide show. With normal slide show mode in effect, the display switchover setting function 85 allows pictures to be scrolled always in the rightward direction during the picture switchover. In shuffle slide show mode, the display switchover setting function 85 enables any one of the rightward, leftward, upward, and downward directions to be selected randomly for a scroll every time pictures are switched. The scroll direction established selectively by the display switchover setting function 85 is signaled by the display control function 81 in the form of an instruction to the display controller 73 in the camera/LCD block 38. In turn, the display controller 73 scrolls the displayed pictures as instructed.

The timing function 86 is designed to keep time. In particular, the slide show display involves showing one picture after another at predetermined intervals of, say, three seconds. Such intervals are counted by the timing function 86.

### 5. Typical Slide Show Processes

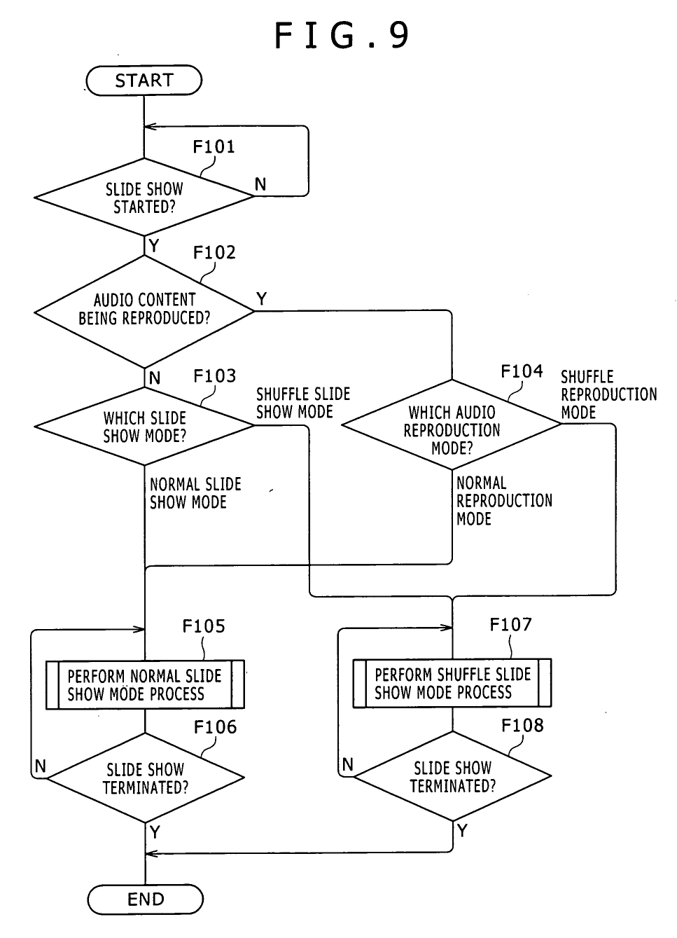

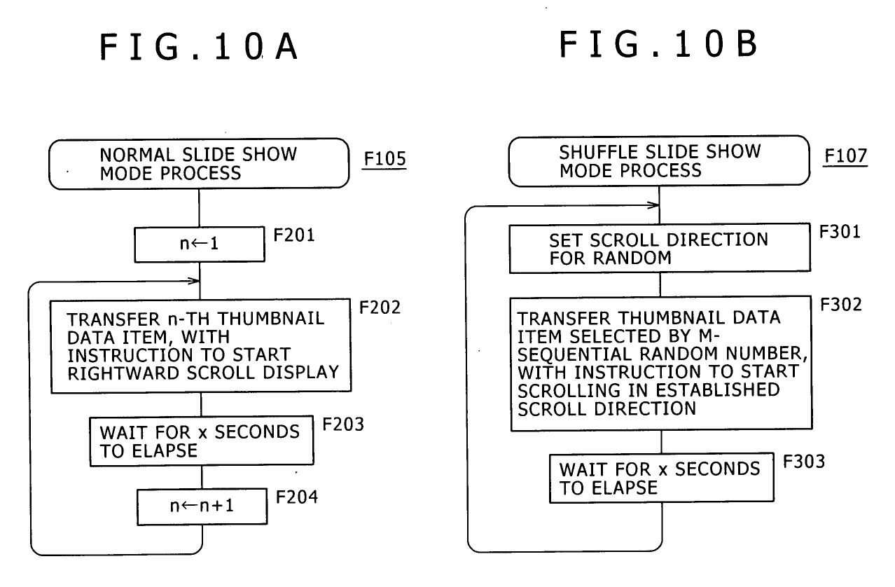

Typical control processes performed by the CPU 30 for effecting slide show displays will now be described along with examples of the slide show in reference to FIGS. 9 through 12J. FIGS. 9, 10A and 10B outline the control processes carried out by the CPU 30 resorting to the functions indicated in FIG. 8. Specifically, FIG. 9 shows steps constituting a typical process executed by the display control function 81 for overall control on the slide show operation. FIGS. 10A and 10B show steps constituting representative processes mainly performed by the thumbnail data selection and transfer function 83, M-sequential random number generating function 84, display switchover setting function 85, and timing function 86.

In step F101 of FIG. 9, the CPU 30 checks for an instruction to start a slide show. Illustratively, the user may give the instruction to execute a slide show by operating the slide show/display key 8. When that instruction is detected by the CPU 30, control is transferred from step F101 to step S102. In step F102, the CPU 30 checks to determine whether audio content data in the audio data file is being reproduced. If the audio content data is not currently reproduced, step F103 is reached. In step F103, the CPU 30 checks to determine which slide show mode is in effect, i.e., normal slide show mode or shuffle slide show mode. One of the slide show modes is selected by the user illustratively operating on a menu screen, or by operation of the slide show/display key 8. In any case, the user-selected slide show mode is detected in step F103. If normal slide show mode is found to be in effect, step F105 is reached in which a normal slide show mode process is performed. If shuffle slide show mode is found in effect, then step F107 is reached in which a shuffle slide show mode process is carried out. What takes place in steps F105 and F107 will be discussed later in more detail with reference to FIGS. 10A and 10B. If the user issues an instruction to end the slide show, then the CPU 30 terminates its slide show operation and ends the slide show process in step F106 or in step F108.

If the slide show is to be carried out during reproduction of audio content data, the CPU 30 goes from step F102 to step F104. In step F104, the CPU 30 checks to determine which audio reproduction mode is in effect, i.e., normal reproduction mode or shuffle reproduction mode. Normal reproduction mode is a mode in which audio content data is reproduced in order of track number under management of the track index file explained with reference to FIG. 5. Shuffle reproduction mode is a mode where audio content data is reproduced in a randomly selected sequence. The audio reproduction mode is selected as desired by the user's operation. If the selected audio reproduction mode is normal reproduction mode, step F105 is reached in which the normal slide show mode process is performed. If the selected audio reproduction mode is shuffle reproduction mode, then step F107 is reached in which the shuffle slide show mode process is carried out. If the user issues an instruction to end the slide show or if the reproduction of audio content data is stopped by the user's operation or is brought to an end because the data has been exhausted, then the CPU 30 terminates its slide show operation and ends the slide show process in step F106 or in step F108.

As described above, the normal slide show mode process in step F105 is performed if the audio content data is being reproduced in normal reproduction mode. If the audio content data is not currently reproduced, the normal slide show mode process is carried out by the user's operation for setting normal slide show mode selectively. The shuffle slide show mode process in step F107 is executed if the audio content data is being reproduced in shuffle reproduction mode. If the audio content data is not currently reproduced, the shuffle slide show mode process is performed by the user's operation for selectively setting shuffle slide show mode.

Detailed steps constituting the normal slide show mode process in step F105 are indicated in FIG. 10A, and detailed steps making up the shuffle slide show mode process in step F107 are depicted in FIG. 10B. The two processes in FIGS. 10A and 10B are carried out mainly by the thumbnail data selection and transfer function 83, M-sequential random number generating function 84, display switchover setting function 85, and timing function 86. While the process in FIG. 10A or 10B is in progress, the thumbnail data buffering function 82 keeps controlling the buffering of necessary thumbnail files TMF into the buffer memory 35. When the normal slide show mode process of FIG. 10A is performed, the thumbnail data buffering function 82 buffers sequentially the first and subsequent thumbnail files TMF under the first and subsequent subdirectories CF in a suitably timed manner. When the shuffle slide show mode process of FIG. 10B is carried out, the thumbnail data buffering function 82 first selects any subdirectory CF using an M-sequential random number and then buffers the thumbnail files TMF in a randomly selective manner based on M-sequential random numbers under that subdirectory CF.

In step F201 of the normal slide show mode process in FIG. 10A, the CPU 30 sets an initial value “1” to a variable “n.” In step F202, the CPU 30 causes the thumbnail data selection and transfer function 83 to select an n-th (i.e., first, in this case) thumbnail data item tm from the thumbnail file TMF being buffered in the buffer memory 35 and to transfer the selected thumbnail data item to the camera/LCD block 38. The CPU 30 further instructs the display controller 73 to display the transferred thumbnail data item tm. In step F203, the CPU 30 waits for the elapse of X seconds constituting a predetermined interval during which one picture is displayed. For example, if pictures are to be switched one after another at intervals of three seconds, the CPU 30 waits for the timing function 86 to count three seconds. Upon elapse of the three-second interval, the CPU 30 goes to step F204 and increments the variable “n” by 1. From step F204, the CPU 30 returns to step F202 to select the n-th (i.e., of data number 2, in this case) thumbnail data item tm and to transfer the selected thumbnail data item to the camera/LCD block 38. The CPU 30 further gives the instruction to display the transferred thumbnail data item tm.

The above process is repeated until the end of the slide show operation. Although not shown in the flowchart of FIG. 10A, when all thumbnail data items tm in a given thumbnail file TMF have been transferred to the camera/LCD block 38, the thumbnail file TMF having the next file number is selected and the thumbnail data items tm are transferred successively from the newly selected file. When all thumbnail data items tm in all thumbnail files TMF under a given subdirectory CF have been displayed, then the first thumbnail file TMF under the next subdirectory is selected and the thumbnail data items tm are transferred consecutively from the newly selected thumbnail file.

In step F202, when a given thumbnail data item tm is transferred to the camera/LCD block 38 so that pictures may be switched on the display, the CPU 30 instructs the display controller 73 to scroll the picture display in the rightward direction. FIGS. 11A through 11J show how displays are typically performed in normal slide show mode. In the first-time step F202, the CPU 30 transfers a thumbnail data item tm1 to the camera/LCD block 38 as shown in FIG. 11A for display onto the display unit 4. In the second-time step F202 upon elapse of X seconds, the CPU 30 transfers the next thumbnail data item tm2 and instructs the display controller 73 to scroll the picture display in the rightward direction. In response, the display controller 73 controls the display data processing device 72 and display drive circuit 71 so that the picture of the thumbnail data tm1 will be scrolled rightward and replaced by the picture of the thumbnail data item tm2, as illustrated in FIGS. 11A, 11B and 11C. Another X seconds later, the CPU 30 transfers the next thumbnail data item tm3 and instructs the display controller 73 to scroll the picture display in the rightward direction. In turn, the display controller 73 causes the picture of the thumbnail data item tm2 on the display unit 4 to be scrolled rightward and replaced by the picture of the thumbnail data item tm3 as shown in FIGS. 11C, 11D and 11E. Thereafter, the pictures are switched successively as the thumbnail data items tm4, tm5, tm6, etc., are transferred consecutively. That is, the current picture is scrolled rightward for switchover to the next picture, as indicated in FIGS. 11E, 11F and 11G for the thumbnail data item tm4; as shown in FIGS. 11G, 11H and 11I for the thumbnail data item tm5; as depicted in FIGS. 11I, 11J, etc., for the thumbnail data item tm6; and so on.

In the normal slide show mode process, as described above, the current picture is always scrolled rightward for switchover to the next picture every time a new thumbnail data item tm is transferred for display in order of data number. The display controller 73 need not be given the instruction to scroll rightward every time a new picture is to be displayed. The display controller 73 need only be notified that normal slide show mode is to be in effect. Once the notification is given, the display controller 73 scrolls the picture display always in the rightward direction.

The shuffle slide show mode process of FIG. 10B will now be described. In step F301 of FIG. 10B, the CPU 30 causes the display switchover setting function 85 to select randomly any one of the rightward, leftward, upward, and downward scroll directions as the display switchover operation. In step F302, the CPU 30 causes the thumbnail data selection and transfer function 83 to transfer to the camera/LCD block 38 a thumbnail data item tm selected by use of an M-sequential random number from the thumbnail file TMF being buffered in the buffer memory 35. The CPU 30 further instructs the display controller 73 to display the transferred thumbnail data item tm by carrying out the display switchover operation selected in step F301. In step F303, the CPU 30 waits for X seconds constituting the interval during which one picture is displayed for the slide show. If pictures are switched at intervals of, say, three seconds, then the CPU 30 waits for the timing function 86 to count three seconds. Following the three-second interval, step F301 is reached again. The CPU 30 again selects any one of the rightward, leftward, upward, and downward scroll directions as the display switchover operation. In step F302, the CPU 30 transfers to the camera/LCD block 38 a thumbnail data item tm selected by use of an M-sequential random number. The CPU 30 further gives an instruction to display the transferred thumbnail data item tm through execution of the display switchover operation selected in step F301.

The above process is repeated until the end of the slide show operation. Although not shown in the flowchart of FIG. 10B, when all thumbnail data items tm in a given thumbnail file TMF have been transferred randomly to the camera/LCD block 38, another thumbnail file TMF randomly selected and buffered is reached and the thumbnail data items tm are transferred randomly from the newly selected file. When all thumbnail data items tm in all thumbnail files TMF under a given subdirectory CF have been displayed, then another randomly selected thumbnail file TMF under another randomly selected subdirectory is reached and the thumbnail data items tm are randomly selected and transferred from the newly selected thumbnail file.

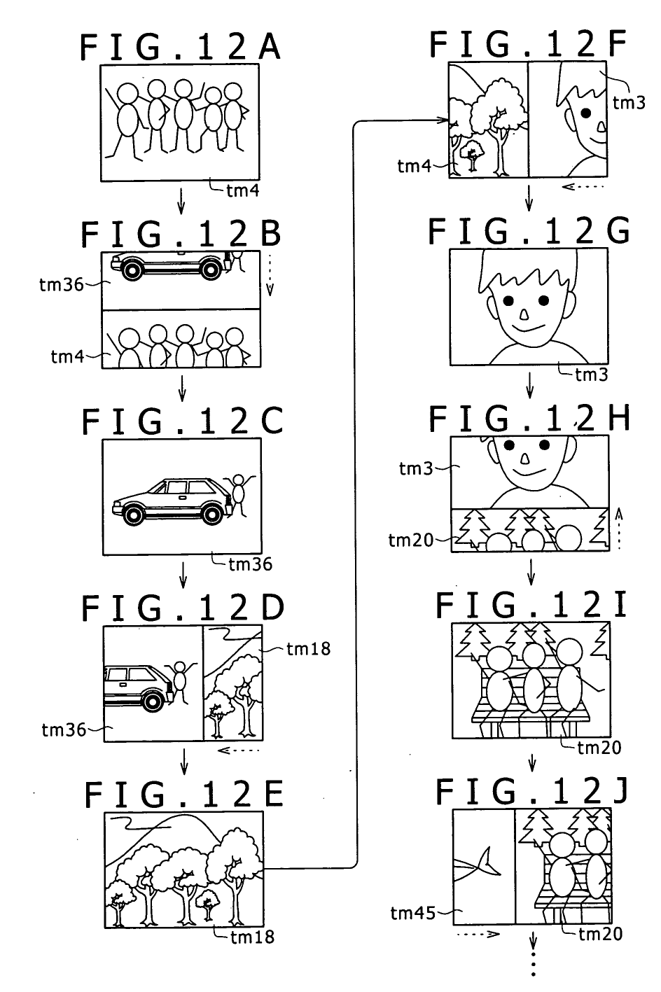

In step F302 of the shuffle slide show mode process, the CPU 30 instructs the display controller 73 to transfer a given thumbnail data item tm to the camera/LCD block 38 for switchover from the current picture to the new picture. At this point, the display controller 73 is instructed to switch pictures in the display switchover operation selected in step F301 that precedes step F302. FIGS. 12A through 12J show how shuffle slide show mode is typically implemented. In a first-time step F302, the CPU 30 transfers a randomly selected thumbnail data item tm4 to the camera/LCD block 38 for display onto the display unit 4 as shown in FIG. 12A. Upon elapse of X seconds, the CPU 30 reaches step F302, transfers another randomly selected thumbnail data tm36, and instructs the display controller 73 to switch the picture display in a downward scroll selected as the display switchover operation. In response, the display controller 73 causes the display data processing device 72 and display drive circuit 71 to get the picture of the thumbnail data item tm4 scrolled downward on the display unit 4 and replaced by the picture of the thumbnail data tm36, as depicted in FIGS. 12A, 12B and 12C. Another X seconds later, the CPU 30 transfers another randomly selected thumbnail data item tm18 and instructs the display controller 73 to switch the picture display in a leftward scroll selected as the display switchover operation. In turn, the display controller 73 causes the picture of the thumbnail data item tm36 to be scrolled leftward on the display unit 4 and replaced by the picture of the thumbnail data item tm18 as depicted in FIGS. 12C, 12D and 12E. Thereafter, as the currently displayed picture is replaced successively by each randomly selected new thumbnail data item (tm3, tm20, tm45, etc.,), the display switchover operation (scroll direction) is also selected randomly at every display switchover and is signaled to the display controller 73. The slide show then takes place in such a manner that the current picture of the thumbnail data item tm18 is scrolled leftward and replaced by the picture of the thumbnail data item tm3 as illustrated in FIGS. 12E, 12F and 12G; that the picture of the thumbnail data item tm3 is scrolled upward and replaced by the picture of the thumbnail data item tm20 as shown in FIGS. 11G, 11H and 11I; that the picture of the thumbnail data item tm20 is scrolled rightward and replaced by the picture of the thumbnail data item tm45 as indicated in FIGS. 11I, 11J, etc.; and so on.

That is, during the shuffle slide show mode process, the thumbnail data items tm are displayed in a random sequence, with the pictures scrolled one after another in a randomly selected direction, i.e., rightward, leftward, upward or downward.

### 6. Effects and Variations of the Embodiment

With the above-described embodiment in normal slide show mode in which pictures are displayed in a predetermined sequence, the display switchover operation for replacing one picture with another is always carried out in a rightward scroll. In shuffle slide show mode, on the other hand, the pictures are switched for a scroll in a randomly selected direction, i.e., rightward, leftward, upward or downward. By looking at how pictures are being switched on the display screen, the user can intuitively recognize the current mode in which the slide show is taking place. The user will have more fun watching the pictures switched one after another in a different manner depending on the mode currently in effect. In particular, shuffle slide mode is easy for the user to recognize since the display switchover operation is performed for a scroll in a randomly selected direction. If audio content data is being reproduced in a predetermined sequence, i.e., in normal reproduction mode, the slide show display is carried out in normal slide show mode. If audio content data is being reproduced in a random sequence, i.e., in shuffle reproduction mode, the slide show display is executed in shuffle slide show mode. That is, the slide show takes place in a manner corresponding to the way the audio content data is currently reproduced. In this case, too, the user can intuitively recognize the slide show mode and audio reproduction mode by watching how pictures are being switched on the displayed screen. With the slide show mode established in conjunction with the audio reproduction mode, the user will have more fun watching the slide show during reproduction of audio content data.

At the time of a slide show display, the above embodiment retrieves each thumbnail file TMF containing thumbnail data items tm from the disc 90, gets the buffer memory 35 to buffer the retrieved file, and randomly selects thumbnail data items tm from the buffered thumbnail file TMF for display purposes. That is, in order to switch randomly the pictures to be displayed on the display unit 4, the thumbnail data items tm need only be read from the buffer memory 35. There is no need to access the disc 90 every time a picture is to be displayed, so that the pictures are displayed randomly in a quickly responding manner. With each thumbnail file TMF read from the disc 90 and buffered, a plurality of pictures to be displayed (i.e., thumbnail data items tm) are efficiently retrieved. This arrangement is particularly advantageous in terms of disc access operations performed by the combination audio-camera apparatus of this invention that uses the disc 90, a recording medium that usually requires a relatively long access time compared with solid-state memories. When a slide show display is performed during audio reproduction in audio mode, this embodiment is not unduly taxed in gaining access to the disc 90. With the reduced burden of accessing the recording medium, this embodiment consumes less power. For a portable apparatus such as this one, reduced power dissipation is a major benefit in view of battery life.

In shuffle slide show mode, thumbnail files TMF are randomly selected. From each thumbnail file TMF, the thumbnail data items tm are randomly selected and retrieved. The randomness in sequencing picture displays thus remains high. That means the embodiment is well fit to provide random displays. When subdirectories CF subsumed under the DCIM directory are also randomly selected, randomness is ensured in three stages: subdirectories CF, thumbnail files TMF, and thumbnail data items tm. All thumbnail data items tm recorded on the disc 90 are then displayed in a highly randomized manner.

Preparatory to performing a slide show, this embodiment buffers picture data not in units of picture data files (DT0001, etc.,) of relatively large sizes but in increments of thumbnail files TMF containing the thumbnail data items tm of a small data size each. This arrangement puts only a small burden on the buffer memory 35. With only the limited capacity taken up in the buffer memory 35 for the slide show, an extensive audio buffering area may be secured in the same memory for concurrent audio reproduction. The ability of the embodiment to buffer audio data thus remains high thanks to this arrangement.

The above-described embodiment has been described merely as an illustration of the present invention. Other diverse variations and modifications of the invention will occur to those skilled in the art. For example, although the picture data for use in slide show displays was shown to be the thumbnail data tm in the foregoing description, this is not limitative of the invention. Alternatively, picture data files (e.g., DT0001 in FIG. 5) may be used for the slide show. In anther variation, the picture data recorded as part of the fringe information in the picture data file may be utilized. A further variation is the use of the thumbnail data under management of the HiFi directory. These are examples that apply to the file management setup of FIG. 5. In addition to the management setup of FIG. 5, this invention may be applied to the slide show of picture data in any format or under any data management scheme when such data is reproduced by suitable apparatuses upon retrieval from recording media such as the disc 90.

The processes in FIGS. 9, 10A and 10B may have their variations. For example, steps F102 and F104 may be omitted. That means the slide show mode is always selected by the user. Another variation may involve omitting step F103, with the slide show carried out in a mode corresponding to the current audio reproduction mode during audio content data reproduction. As a further variation, when the user designates a slide show mode during audio reproduction, only the slide show in the designated mode may be performed without the audio reproduction mode being in effect. In the foregoing description, the CPU 30 in shuffle slide show mode was shown setting its display switchover operation in steps F301 and F302 and giving relevant instructions to the display controller 73. Alternatively, the CPU 30 may notify the display controller 73 of shuffle slide show mode, with the display controller 73 prompted to select the display switchover operation randomly every time a new picture is to be displayed. In other words, the display controller 73 may be equipped with the display switchover setting function 85 shown in FIG. 8. As another alternative, the CPU 30 may be furnished with all control functions of the display controller 73 so as to provide display drive control directly.

In the foregoing description, the combination audio-camera apparatus was shown as one preferred embodiment of the present invention. Alternatively, the invention may be applied to a camera device with no audio capability. The invention may further be applied to diverse apparatuses that perform slide shows of recorded picture data. The invention may also be applied to apparatuses which have no display unit and which transmit slide show display data to an externally connected monitor display.

In the foregoing description, the disc 90 based on the Mini-Disc standard was cited as the typical recording medium on which to record audio data and picture data. Alternatively, other embodiments of the present invention may adopt optical discs based on other standards as their recording media, including CD (Compact Disc), DVD (Digital Versatile Disc) and Blu-Ray Disc. Obviously, diverse kinds of other recording media may also be adopted, including magnetic disc media such as HDD (hard disc drives), magnetic tape media, memory cards containing solid-state memories, solid-state memory devices, and others.

According to the present invention, displays are switched in a first display style in the predetermined sequence display mode such as normal slide show mode, and in a second display style in the random sequence display mode such as shuffle slide show mode. The first and the second display styles differ from each other in terms of the type of display switchover operation or the way the changeover operation is selected. For the above-described embodiment of this invention, the first display style is envisaged illustratively as a rightward scroll operation and the second display style as a scroll operation in a randomly selected direction (upward, downward, leftward, rightward). These styles are only examples; there may be diverse variations of the first and the second display styles.

In particular, besides rightward, leftward, upward and downward scrolls, there may be numerous variations of the display switchover operation, such as a picture change through fade-out/in or through mosaic generation, one picture being replaced by another through overlap, and an instantaneous switch from one picture to another with no image effects. As variations of the first and the second display styles, there may be diverse types of different display switchover operations and changeover operation selecting schemes as listed below.

<1> First display style: rightward scroll

Second display style: leftward scroll

<2> First display style: rightward scroll

Second display style: upward, downward, leftward or rightward scroll, randomly selected

<3> First display style: leftward scroll

Second display style: fade-out/in

<4> First display style: upward scroll

Second display style: mosaic generation

<5> First display style: no effects

Second display style: mosaic generation

<6> First display style: upward, downward, rightward or leftward scroll, randomly selected

Second display style: fade-out/in

<7> First display style: upward, downward, rightward and leftward scrolls, selected sequentially

Second display style: mosaic generation

<8> First display style: upward, downward, rightward or leftward scroll, randomly selected

Second display style: fade-out/in, mosaic generation or overlap, randomly selected

<9> First display style: upward, downward, rightward and leftward scrolls, selected sequentially

Second display style: fade-out/in, mosaic generation or overlap, randomly selected

<10> First display style: upward, downward, rightward and leftward scrolls, selected sequentially

Second display style: fade-out/in, mosaic generation and overlap, selected sequentially

In the foregoing description, the first display style was shown to be one or a plurality of particular display switchover operations for switching pictures, and the second display style was shown being one or a plurality of specific display switchover operations that are different from those of the first display style. Obviously, there may be many other variations of the first and the second display styles depending on the choices and combinations of diverse switchover operations.

Alternatively, the first display style may be set to be always the same display switchover operation, with the second display style left to be a randomly selected display switchover operation. The above-described embodiment of the present invention corresponds to this example, and so does the variation <2> above. There are still other variations as listed below.

<11> First display style: rightward scroll

Second display style: fade-out/in, mosaic generation or overlap, randomly selected

<12> First display style: no effects

Second display style: rightward, upward, downward or leftward scroll, randomly selected

<13> First display style: fade-out/in

Second display style: rightward, upward, downward or leftward scroll; mosaic generation or overlap, randomly selected

<14> First display style: rightward scroll

Second display style: upward or downward scroll, randomly selected

<15> First display style: rightward scroll

Second display style: upward, downward or leftward scroll; fade-out/in, mosaic generation, overlap or no effects, randomly selected

<16> First display style: rightward scroll

Second display scroll: rightward, upward, downward or leftward scroll; fade-out/in, mosaic generation, overlap or no effects, randomly selected

<17> First display style: mosaic generation

Second display style: rightward, upward, downward or leftward scroll; fade-out/in, mosaic generation or overlap, randomly selected

<18> First display style: fade-out/in

Second display style: fade-out/in, mosaic generation or overlap, randomly selected

The variations <11> through <17> and <2> above, as well as the above-described embodiment of the present invention were shown having the first display style fixed to a particular display switchover operation taking place in the predetermined sequence display mode, with the second display style left to be a randomly selected display switchover operation occurring in the random sequence display mode. The types of display switchover operations randomly selected as the second display style may include those display switchover operations that are adopted for the first display style as in the variations <16> through <18> above, or exclude those operations used for the first display style as in the variations <11> through <15> above. Obviously, more variations are conceivable through other combinations. Other image effects not described above may also be adopted as display switchover operations.

According to the present invention, pictures are switched on the display screen in the first display style if the predetermined sequence display mode is in effect, or in the second display style if the random sequence display mode is in use. Simply watching pictures switched on the display screen allows the user intuitively to recognize the current mode in which the pictures are displayed one after another. With the pictures switched in a different display style depending on the mode in effect, the user will have more fun checking what is being displayed. If audio content data is being reproduced in a predetermined sequence audio reproduction mode, then pictures are reproduced in the predetermined sequence display mode. If audio content is being reproduced and output in a random sequence audio reproduction mode, then pictures are reproduced in the random sequence display mode. That means the pictures are displayed in a sequence reflecting the way the audio content data is being reproduced. By looking at how pictures are switched on the display screen, the user can intuitively recognize not only the current display sequence mode but also the audio content data reproduction mode in effect. Because the display sequence mode is established in conjunction with the current audio content data reproduction mode, the user will have more fun watching the pictures displayed one after another during audio content data reproduction.

It should be understood by those skilled in the art that various modifications, combinations, sub-combinations and alterations may occur depending on design requirements and other factor in so far as they are within the scope of the appended claims or the equivalents thereof.

What is claimed is:

1. A reproducing apparatus for reproducing picture data from a recording medium, said reproducing apparatus comprising:
a reading device reading picture data from said recording medium on which said picture data is recorded; and
a controlling device controlling a predetermined sequence display mode and a random sequence display mode in which said picture data is read by said reading device from said recording medium for display, said predetermined sequence display mode being a mode in which a plurality of items of said picture data are output for display in a predetermined sequence, said random sequence display mode being a mode in which said plurality of items of said picture data are output for display in a random sequence, said controlling device further switching said picture data for consecutive display in a first display style when said predetermined sequence display mode is in effect and in a second display style when said random sequence display mode is in effect, said second display style being different from said first display style in terms of picture data switchover on a display screen.

2. The reproducing apparatus according to claim 1, further comprising a displaying device outputting and displaying said picture data read by said reading device form said recording medium.

3. The reproducing apparatus according to claim 1, further comprising an operating device operable to select either of said predetermined sequence display mode and said random sequence display mode, wherein said controlling device selects either of said predetermined sequence display mode and said random sequence display mode based on the operation of said operating device.

4. The reproducing apparatus according to claim 1, wherein said recording medium has audio content data recorded thereon in addition to said picture data;
wherein said reading device reads said picture data and said audio content data from said recording medium;
wherein said controlling device controls a predetermined sequence audio reproduction mode in which a plurality of items of said audio content data are read by said reading device from said recording medium for reproduction and output in a predetermined sequence, and a random sequence audio reproduction mode in which said plurality of items of said audio content data are read for reproduction and output in a random sequence; and
wherein, when displaying said picture data consecutively during reproduction of said audio content data, said controlling device controls said predetermined sequence display mode if said audio content data is being reproduced in said predetermined sequence audio reproduction mode, said controlling device further controlling said random sequence display mode if said audio content data is being reproduced in said random sequence audio reproduction mode.

5. The reproducing apparatus according to claim 1, wherein said recording medium records as said picture data a plurality of still picture data files and a plurality of thumbnail files each corresponding to each of said still picture data files; and
wherein said controlling device causes said reading device to read said thumbnail files when displaying said picture data consecutively.

6. The reproducing apparatus according to claim 1, wherein said first display style is a style in which said picture data is displayed in a predetermined display switchover operation every time said picture data is switched for consecutive display; and
wherein said second display style is a style in which said picture data is displayed in a random display switchover operation every time said picture data is switched for consecutive display.

7. The reproducing apparatus according to claim 1, wherein said first display style is a style in which said picture data is displayed in one or a plurality of predetermined display switchover operations every time said display data is switched for consecutive display; and
wherein said second display style is a style in which said picture data is displayed in one or a plurality of display switchover operations different from said one or said plurality of predetermined display switchover operations every time said picture data is switched for consecutive display.

8. A display controlling method for reproducing picture data from a recording medium, said display controlling method comprising the steps of:
determining whether a predetermined sequence display mode or a random sequence display mode is in effect, said predetermined sequence display mode being a mode in which a plurality of items of said picture data are output for display in a predetermined sequence, said random sequence display mode being a mode in which said plurality of items of said picture data are output for display in a random sequence;
if said predetermined sequence display mode is found in effect, then outputting said plurality of items of said picture data for display in said predetermined sequence while switching said picture data for consecutive display on a display window in a first display style; and
if said random sequence display mode is found in effect, then outputting said plurality of items of said picture data for display in said random sequence while switching said picture data for consecutive display on said display window in a second display style different from said first display style.

9. The display controlling method according to claim 8, wherein, during a consecutively switched display of said picture data while audio content data is being reproduced and output from said recording medium, said determining step determines that said predetermined sequence display mode is in effect if a plurality of items of said audio content data are being reproduced and output in a predetermined sequence in a predetermined sequence audio reproduction mode, said determining step further determining that said random sequence display mode is in effect if said plurality of items of said audio content data are being reproduced and output in a random sequence in a random sequence audio reproduction mode.

10. A reproducing apparatus for reproducing audio data and picture data from a recording medium, said reproducing apparatus comprising:
reading means for reading said audio data and said picture data from said recording medium;
audio reproducing means for reproducing said audio data read from said recording medium;
picture data reproducing means for reproducing said picture data read from said recording medium;
inputting means for inputting either a predetermined sequence reproduction setting or a random sequence reproduction setting specifying whether said audio data is to be reproduced in a predetermined sequence or in a random sequence by said audio reproducing means;
picture switchover controlling means for controlling switchover from one picture to another derived from said picture data reproduced by said picture data reproducing means; and
controlling means for allowing said audio data to be reproduced by said audio reproducing means in said predetermined sequence if said predetermined sequence reproduction setting is input through said inputting means while causing said picture switchover controlling means to perform the picture switchover in a predetermined style, said controlling means further allowing said audio data to be reproduced in said random sequence if said random sequence reproduction setting is input through said inputting means while causing said picture switchover controlling means to perform the picture switchover in a random style.

11. The reproducing apparatus according to claim 10, further comprising displaying means for displaying said picture data output by said picture data reproducing means.

12. The reproducing apparatus for reproducing audio data and picture data from a recording medium, said reproducing apparatus comprising:
a reading device reading said audio data and said picture data from said recording medium;
an audio reproducing device reproducing said audio data read from said recording medium;
a picture data reproducing device reproducing said picture data read from said recording medium;
an inputting device inputting either a predetermined sequence reproduction setting or a random sequence reproduction setting specifying whether said audio data is to be reproduced in a predetermined sequence or in a random sequence by said audio reproducing device;
a picture switchover controlling device controlling switchover from one picture to another derived from said picture data reproduced by said picture data reproducing device; and
a controlling device allowing said audio data to be reproduced by said audio reproducing device in said predetermined sequence if said predetermined sequence reproduction setting is input through said inputting device while causing said picture switchover controlling device to perform the picture switchover in a predetermined style, said controlling device further allowing said audio data to be reproduced in said random sequence if said random sequence reproduction setting is input through said inputting device while causing said picture switchover controlling device to perform the picture switchover in a random style.

13. The reproducing apparatus according to claim 12, further comprising a displaying device displaying said picture data output by said picture data reproducing device.
